(19) United States
(12) Patent Application Publication
(10) Pub. No.: US 2009/0283341 A1
(43) Pub. Date: Nov. 19, 2009

(54) Input device and control method thereof

(75) Inventor: Tsung-Hsi Lin, Taipei County (TW)

Correspondence Address: BACON & THOMAS, PLLC, 625 SLATERS LANE, FOURTH FLOOR, ALEXANDRIA, VA, 22314-1176, US

(73) Assignee: KYE SYSTEMS CORP., Taipei County (TW)

(21) Appl. No.: 12/285,265

(22) Filed: Oct. 1, 2008

(30) Foreign Application Priority Data
May 16, 2008 (TW) 097118251

(51) Int. Cl. G06F 3/041

(52) U.S. Cl. 178/18.09

(57) ABSTRACT

An input device and a control method thereof are described. The input device includes an optical trace-detecting module, an instruction determining module, and an instruction code transmitting module. A finger moving signal is received by the optical trace-detecting module, an input rotating instruction is judged according to the finger moving signal, and then a rotating instruction code corresponding to an angle is transmitted.

### CROSS-REFERENCE TO RELATED APPLICATIONS

This non-provisional application claims priority under 35 U.S.C. §119(a) on Patent Application No(s). 097118251 filed in Taiwan, R.O.C. on May 16, 2008 the entire contents of which are hereby incorporated by reference.

### BACKGROUND OF THE INVENTION

1. Field of Invention

The present invention relates to an input method, and more particularly to a control method of an input device.

2. Related Art

As computer software interfaces are more and more human-oriented, computer operation totally depends on manipulation of a mouse. The mouse is usually used to control a cursor displayed in a display device. The mouse enables a user to directly perform the vertical scrolling by using a mouse wheel in web browsing. In addition, the mouse further includes a plurality of buttons, which can be set to different function definitions, such that the computer software or the user can define and perform specific functions.

FIG. 1 is a schematic view of a mouse using the OPTO-wheel scroll technology in the market. Referring to FIG. 1, a mouse 100 has a left button 110, a right button 120, and an optical trace-detecting module 130. The optical trace-detecting module 130 is installed between the left button 110 and the right button 120 to replace the mouse wheel of the mouse 100, such that an index finger of the user can draw tracks on the optical trace-detecting module 130. For the related technique, please refer to U.S. Pat. No. 7,298,362.

When the finger of the user slides forward and backward on the optical trace-detecting module 130, signals read by the optical trace-detecting module 130 are used as forward and backward-scrolling input signals of a mouse wheel. In another aspect, when the finger of the user slides left and right on the optical trace-detecting module 130, X axis signals read by the optical trace-detecting module 130 are used as left and right-moving input signals of a lateral scroll bar of a window interface.

However, as the Internet applications and computer software are continuously developed and the user depends more and more on the mouse, and the functions of the original buttons cannot satisfy the future application trend of the mouse, so it is necessary to improve the functions of the existing mouse and to develop a mouse capable of satisfying the future application.

Many hardware manufacturers of input devices intend to provide more diversified input functions without increasing the hardware cost, so as to satisfy the diversified requirements for mice on operation in the future and to enhance the product competitiveness.

### SUMMARY OF THE INVENTION

In view of the above, the present invention is directed to providing a control method of an input device, in which a rotating function is added on the input device having an optical trace-detecting module, so as to enhance the practicability.

In order to achieve the objective of the present invention, the input device of the present invention includes an optical trace-detecting module, an instruction determining module, and an instruction code transmitting module, for receiving a finger moving signal, judging whether the finger transmits a rotating instruction or not according to the finger moving signal, and then transmitting an instruction code corresponding to a rotating angle.

The feature of the present invention is that positive and negative output changes of X axis and Y axis generated when the finger circularly moves on the optical trace-detecting module are used as continuous signals output in the two directions, and the direction changes of the two continuous signals are monitored, so as to judge whether a rotating action is performed or not and to judge the rotating directions, thereby providing the rotating instruction input function.

Accordingly, the present invention can be applied to a mouse using the OPTO-wheel scroll technology and having a rotation detecting function. In addition, except for the original functions, without adding any parts, at least two keyboard or mouse button functions can be added (for example, “volume up button Volume+”, “volume down button Volume−”, “game control button B4”, and “game control button B5”). In addition to being applied in a common computer input device, the present invention can also be applied in a display device (for example a digital photo frame or a display) or an audio device (for example a loudspeaker or an earphone).

In another aspect, the present invention provides a control method of an input device. In the method, a finger of a user transmits a signal to a computer through a clockwise or anticlockwise rotating track on an optical detecting module, for commanding the computer to execute specific functions or programs, for example zoom in/out, or Flip 3D function in Windows Vista.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a conventional mouse using the OPTO-wheel scroll technology;

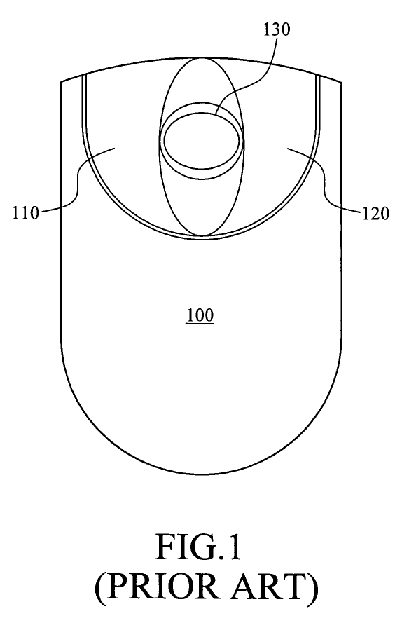

FIG. 2 is a schematic view illustrating an embodiment of the present invention;

FIG. 3 is a schematic view illustrating an instruction determining module according to the embodiment of the present invention;

FIG. 4 is a flow chart of a computer input method according to an embodiment of the present invention;

FIG. 5A is a view of the stroke sequence of number 2;

FIG. 5B is a view of the stroke sequence of the number 8; and

FIG. 5C is a view of the stroke sequence of the character L.

### DETAILED DESCRIPTION OF THE INVENTION

The objectives and the implementing methods of the present invention are described in detail in preferred embodiments as follows. However, the concept of the present invention may also be used in other scopes. The embodiments listed below are only used to illustrate the objectives and the implementing methods of the present invention, but are not used to limit the scope of the present invention. The applications of the input device of the present invention can be but is not limited to computer peripherals (for example a mouse, keyboard, or game controller), display devices (for example a display screen or digital photo frame), or audio devices (a loudspeaker, earphone, or speaker).

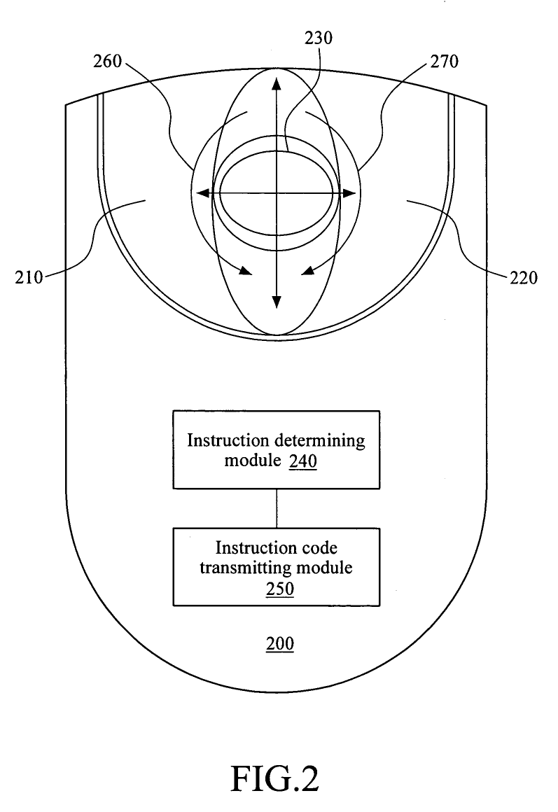

FIG. 2 is a schematic view of an embodiment of the present invention. In order to simplify the description, a mouse is used to describe the implementation of the present invention. Referring to FIG. 2, a mouse 200 has a left button 210, a right button 220, and an optical trace-detecting module 230, for transmitting a mouse signal to a computer. The optical trace-detecting module 230 is installed between the left button 210 and the right button 220, such that an index finger of the user transmits an instruction action on the optical trace-detecting module 230. According to the present invention, when the finger of the user slides on the optical trace-detecting module 230, an instruction determining module 240 can judge whether the rotating instruction input by the user is a clockwise rotating instruction 270 or an anticlockwise rotating instruction 260 according to the change of the read signal. Then, an instruction code transmitting module 250 transmits a corresponding instruction code to the computer according to the clockwise rotating instruction 270 or the anticlockwise rotating instruction 260.

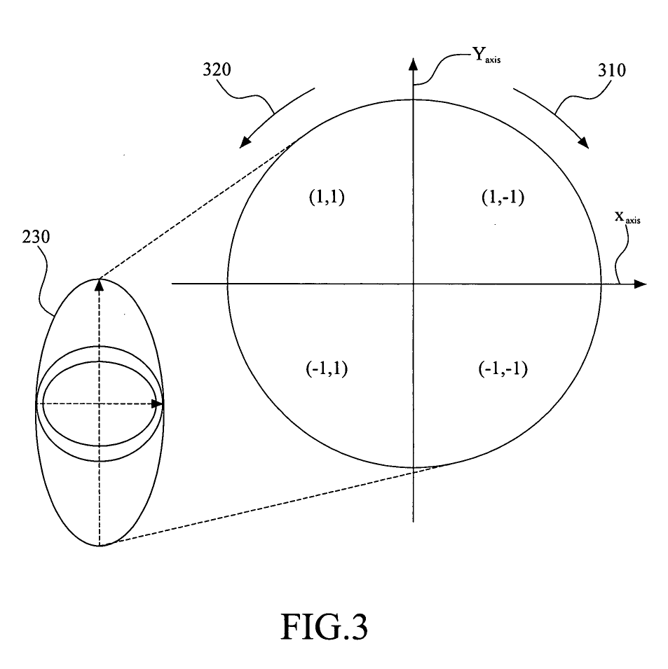

FIG. 3 is a schematic view illustrating the instruction determining module for judging the rotating signal based on the positive and negative directions of the X axis and Y axis signals according to the embodiment of the present invention. It is assumed that the finger movement from left to right on the X axis is in a positive direction, and the movement from right to left is in a negative direction (that is, the rotating movement from left to right). At the same time, it is assumed that the finger movement from bottom to top on the Y axis is in a positive direction, and the movement from top to bottom is in a negative direction (that is, the rotating movement from bottom to top). Therefore, the coordinates of the finger are (1, 1) when it starts to rotate in the second quadrant of the original XY coordinate system, (1, −1) in the first quadrant, (−1, −1) in the fourth quadrant, and (−1, 1) in the third quadrant.

Referring to FIG. 3, when the user triggers the signal (clockwise rotating signal 310) in a manner of rotating in a clockwise direction, the optical trace-detecting module receives (1, 1), (1, −1), (−1, −1), (−1, 1) coordinate signals in sequence, so the X coordinate values of the coordinate signals change in a sequence of 1, 1, −1, −1, and the Y coordinate values of the coordinate signals change in a sequence of 1, −1, −1, 1. Then, the instruction determining module judges that the user transmits a clockwise rotating signal according to the sequences in which the X and Y coordinate values change. Next, the instruction code transmitting module transmits the instruction code corresponding to the clockwise rotating instruction to the computer.

Similarly, when the user triggers the signal (anticlockwise rotating signal 320) in a manner of rotating in an anticlockwise direction, the optical trace-detecting module receives (1, 1), (−1, 1), (−1, −1), (1, −1) coordinate signals in sequence, so the X coordinate values of the coordinate signals change in a sequence of 1, −1, −1, 1, and the Y coordinate values of the coordinate signals change in a sequence of 1, 1, −1, −1. Then, the instruction determining module judges that the user transmits an anticlockwise rotating signal according to the sequences in which the X arid Y coordinate values change. Next, the instruction code transmitting module transmits the instruction code corresponding to the anticlockwise rotating instruction to the computer.

In the mouse according to the embodiment of the present invention, the instruction corresponding to the input signal is to anticlockwise rotation for 360 degrees (1 circle) or clockwise rotation for 360 degree (1 circle). However, in actual applications, the rotating instruction is not limited to combinations of any angle or any circles, and the manufacturers can randomly adjust and combine the application of the rotating instruction according to the operating habits of users or the software program requirements.

Accordingly, persons skilled in the art can easily understand that more than one method can be used to realize the rotation judgment manners of the present invention. In addition to the method provided in the embodiment, more judgment manners can be used. For the embodiment of the present invention, though the rotation judgment manner can be realized in various methods, the main objective is to provide a new information input manner through the rotation detecting module, such that is the user can operate the computer more conveniently. For hardware manufacturers, the instruction code corresponding to the rotating signal of the embodiment can be to any functional instruction (for example “volume up button Volume+”, “volume down button Volume−”, “button B4”, or “button B5”) by the manufacturers or users.

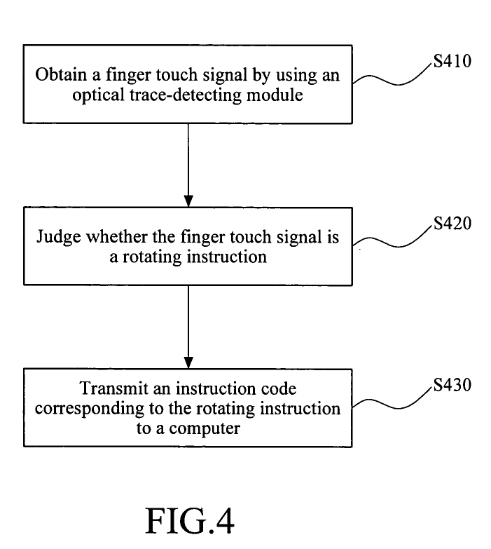

FIG. 4 is a flow chart of a control method of the input device according to an embodiment of the present invention. In order to simplify the description, a mouse having an optical trace-detecting module is used to describe the implementation of the present invention. According to the present invention, the optical trace-detecting module obtains a finger moving signal (Step S410). Then, it is judged whether the finger moving signal is a rotating instruction (Step S420). Next, an instruction code corresponding to the rotating instruction is transmitted to the computer (Step S430).

Persons skilled in the art can easily understand that the control method of the input device of the embodiment can be recorded in a firmware of the input device as a program. Therefore, without increasing the hardware element, a mouse having the optical sensing function and carrying the method of the present invention can realize more input manners (left rotating, right rotating, or the rotating instruction of any rotating angle). In another aspect, in addition to increasing the functional instructions of the mouse (for example “volume up button Volume+”, “volume down button Volume−”, “game control button B4”, or “game control button B5”), in actual applications, the rotation detecting function can be applied to computer programs in a combined button manner. For example, when the user presses the “Shift” key on the keyboard and inputs a rotating signal from the mouse, the computer program can define the signal as an instruction of another specific function. Similarly, it may be deducted that the combined button may include any key on the keyboard, including any one of Shift, Ctrl, Alt, a, b, c, d, e, f, g, h, i, j, k, l, m, n, o, p, q, r, s, t, u, v, w, x, y, and z. The user can use any key and the rotating instruction of the mouse to define various combinations of key functions, which is applicable to the setting of hot keys for specific functions of various software programs.

The instructions are not only the said clockwise rotating instruction 270 or the anticlockwise rotating instruction 260, but also the combination signals of the different quadrants. In the other word, the instruction determining module judges that the combination instruction according to continuous signals of touching different areas of the optical trace-detecting module in sequence by the finger.

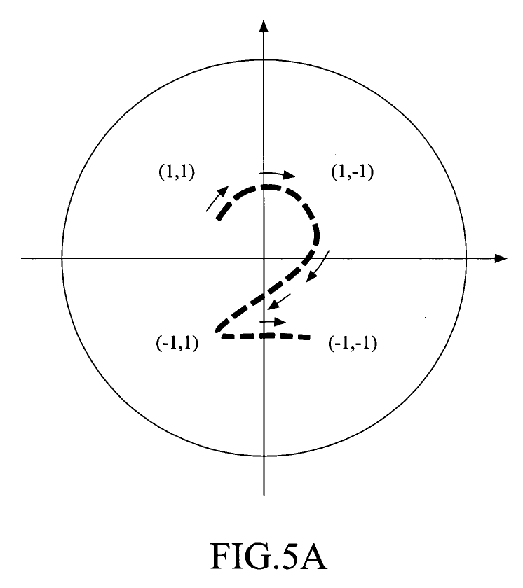

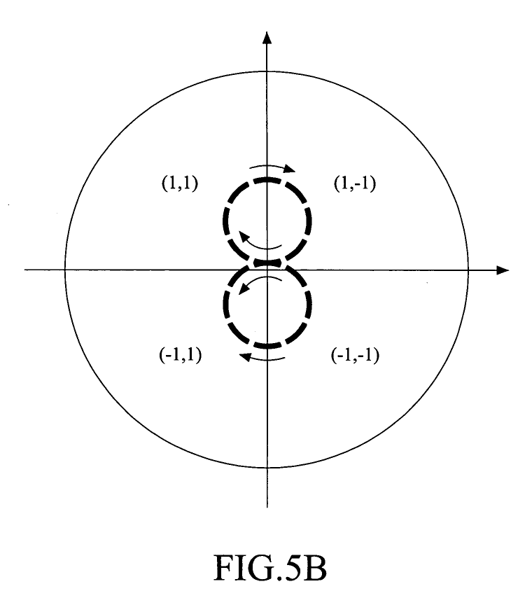

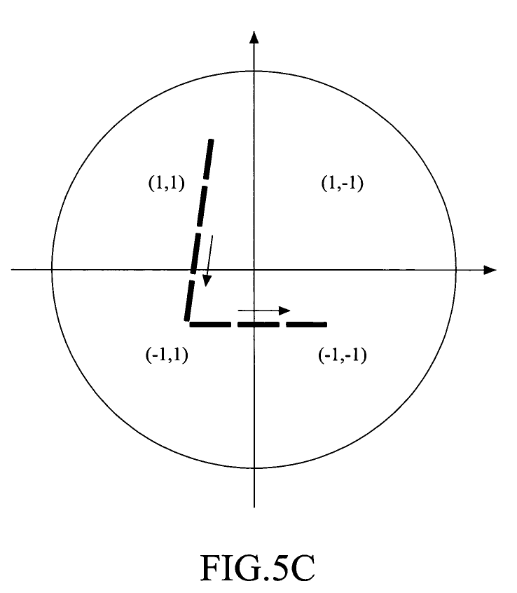

For example, detecting the signal of number 2 form the optical trace-detecting module. The user writes the number 2 on the optical trace-detecting module according to the stroke sequence as the FIG. 5A. The optical trace-detecting module receives (1,1), (1,−1) (−1,−1) (−1,1), (−1,−1) coordinate signals in sequence. the X coordinate values of the coordinate signals change in a sequence of 1, 1, −1, −1, −1, and the Y coordinate values of the coordinate signals change in a sequence of 1, −1, −1, 1, −1. Then, the instruction determining module judges that the user transmits a corresponding signal according to the sequences in which the X and Y coordinate values change. The combination signals can be applied to character or number. Please referring to the FIG. 5B and 5C, it is a view of the stroke sequence of the number 8 and character L. Furthermore, persons skilled in the art can easily understand that more than one method can be used to realize the combination judgment manners of the present invention.

In addition to importing the trace to the optical trace detecting module directly, the invention associates the different buttons for another instruction. For example, when the user presses the “Ctrl” key on the keyboard and inputs a combo signal from the mouse, the computer program can define the signal as an instruction of another specific function.

It should be noted that when the present invention is applied to different products, the generated rotating instructions are not only used to execute the rotating action. That is, the rotating instructions can be used to execute different functions, for example, the clockwise rotating instruction can represent an instruction for scrolling a page from top to bottom, and the anticlockwise rotating instruction can represent an instruction for scrolling a page from bottom to top. Further, for example, the clockwise rotating instruction can represent a volume up instruction, and the anticlockwise rotating instruction can represent a volume down instruction. Further, the clockwise rotating instruction can represent a page down instruction, and the anticlockwise rotating instruction can represent a page up instruction. Further, for example, the anticlockwise and clockwise rotating instructions can represent zoom in and zoom out of pictures or front, menu selection of dialog boxes, and switching between applications. The above also fall into the scope of the present invention.

What is claimed is:

1. An input device, comprising:
an optical trace-detecting module, for receiving a plurality of finger moving signals finger moving signal;
an instruction determining module, for judging whether to transmit a rotating instruction or not according to the finger moving signal; and
an instruction code transmitting module, for transmitting an instruction code corresponding to the rotating instruction to a computer,
wherein the instruction determining module determines whether to trigger the rotating instruction or not according to a variation which relates to a sequence of the finger moving signals between X axis and Y axis in positive and negative directions.

2. The input device according to claim 1, further comprising:
a recording module, for recording a finger touch area of a finger on the optical trace-detecting module in a time period, wherein the finger touch area is any one of several areas divided on the optical trace-detecting module.

3. The input device according to claim 2, wherein the instruction determining module judges that the rotating instruction is a right rotating instruction according to continuous signals of touching top, right, bottom, and left areas of the optical trace-detecting module in sequence by the finger.

4. The input device according to claim 2, wherein the instruction determining module judges that the rotating instruction is a left rotating instruction according to continuous signals of touching top, left, bottom, and right areas of the optical trace-detecting module in sequence by the finger.

5. A control method of an input device, comprising:
obtaining a finger moving signals by using an optical trace-detecting module;
judging whether to transmit a rotating instruction or not according to the finger moving signal; and
transmitting an instruction code corresponding to the rotating instruction to a computer,
wherein judging whether to trigger the rotating instruction or not according to a variation which relates to a sequence of the finger moving signals between X axis and Y axis in positive and negative directions.

6. The control method of an input device according to claim 5, further comprising:
a recording module, for recording a finger touch area of a finger on the optical trace-detecting module in a time period, wherein the finger touch area is any one of several areas divided on the optical trace-detecting module.

7. The control method of an input device according to claim 5, wherein the instruction determining module judges that the rotating instruction is a right rotating instruction according to continuous signals of touching top, right, bottom, and left areas of the optical trace-detecting module in sequence by the finger.

8. The control method of an input device according to claim 5, wherein the instruction determining module judges that the rotating instruction is a left rotating instruction according to continuous signals of touching top, left, bottom, and right areas of the optical trace-detecting module in sequence by the finger.

9. A control method of an input device, comprising:
obtaining a finger moving signals by using an optical trace-detecting module;
judging whether to transmit a combination instruction or not according to the finger moving signal; and
transmitting an instruction code corresponding to the combination instruction to a computer,
wherein judging whether to trigger the rotating instruction or not according to a variation which relates to a sequence of the finger moving signals between X axis and Y axis in positive and negative directions.

10. The control method of an input device according to claim 5, further comprising:
a recording module, for recording a finger touch area of a finger on the optical trace-detecting module in a time period, wherein the finger touch area is any one of several areas divided on the optical trace-detecting module.

11. The control method of an input device according to claim 5, wherein the instruction determining module judges that the combination instruction according to continuous signals of touching different areas of the optical trace-detecting module in sequence by the finger.
